(19) United States
(12) Patent Application Publication
(10) Pub. No.: US 2005/0096948 A1
(43) Pub. Date: May 5, 2005

(54) Method to analyze a proposed venture transaction

(75) Inventors: Lawton Chen, Essex (GB); Dar Wolford, Northville, MI (US); William King JR., Grosse Ile, MI (US); Russell Louks, Woodhaven, MI (US); Kenneth Cornell, Pinckney, MI (US); Norman Rubin, Franklin, MI (US)

Correspondence Address: BROOKS KUSHMAN P.C./FGTL, 1000 TOWN CENTER, 22ND FLOOR, SOUTHFIELD, MI, 48075-1238, US

(73) Assignee: Ford Motor Company, Dearborn, MI (US)

(21) Appl. No.: 10/696,345

(22) Filed: Oct. 29, 2003

(51) Int. Cl. G06F 17/60

(52) U.S. Cl. 705/7

(57) ABSTRACT

A system and method to analyze a proposed venture transaction. The analysis comprises any one of a merger, acquisition, joint venture, or other venture transaction. The analysis further comprises predicting information technology capabilities of an entity formed according to the proposed venture transaction.

### BACKGROUND OF THE INVENTION

1. Field of the Invention

The present invention relates to a method to analyze a proposed venture transaction between at least two entities. The method facilitates prediction of the information capabilities of an entity formed according to the proposed venture transaction.

2. Background Art

A venture transaction generally refers to a transaction where two or more existing entities form a new entity. Commonly, the venture transaction is a merger, an acquisition, a joint venture, or a divestiture.

The object of the venture transaction is to achieve a desired benefit. Information technology (IT) capabilities of the newly formed entity are a factor in the achieving the desired benefit. Insufficient IT capabilities can lead to business interruptions, hardware and software incompatibilities, violations of third party software license agreements, loss of intellectual property, and inappropriate sharing of data. Accordingly, there exists a need to provide a method to predict the IT capabilities of the newly formed entity.

### SUMMARY OF THE INVENTION

The need identified above is addressed by the present invention. The present invention provides a method for use with a computerized system. The method analyzes a proposed venture transaction to predict information technology (IT) capabilities of a new entity formed in accordance with the proposed venture transaction.

The analysis method comprises collecting data regarding IT capabilities. The data is collected from two or more entities which are to form the new entity. The collected data is analyzed to determine which IT capabilities from the two entities are to comprise the IT capabilities of the new entity. For example, the analysis determines whether the new entity will include IT capabilities from one or both of the entities. The analysis relies upon a number of electronically accessible documents. The documents are required to provide instructions to facilitate the analysis.

One aspect of the analysis method relates to recommending whether to proceed with the proposed venture transaction. The recommendation is made based upon the analysis determination of the IT capabilities of the new entity. Preferably, the recommendation the IT capabilities are safe and legal and the IT capabilities are sufficient to prevent software incompatibilities at day-one. The electronically accessible documents facilitate making such a recommendation.

One aspect of the method relates to recommending an implementation plan. The implementation plan can be used in transferring the IT capabilities of each entity which are to comprise the IT capabilities of the new entity. The implementation plan is recommended only after recommending to proceed with the proposed venture transaction and in accordance with analysis instructions provided in an implementation document electronically maintained in the computerized system.

### BRIEF DESCRIPTION OF THE DRAWINGS

FIG. 1 illustrates a computer-implemented system;

FIG. 2 illustrates a flowchart to facilitate analyzing a proposed venture transaction;

FIG. 3 illustrates a pre-preparation document;

FIG. 4 illustrates a file folder arrangement;

FIG. 5 illustrates a selection of a folder in the file folder arrangement shown in FIG. 4;

FIG. 6 illustrates a complete preparation document;

FIG. 7 illustrates an established transition services in a security document;

FIG. 8 illustrates a negotiate binding agreement document;

FIG. 9 illustrates an implementation plan document; and

FIG. 10 illustrates a feedback process improvement document.

### DETAILED DESCRIPTION OF THE PREFERRED EMBODIMENT(S)

A venture transaction refers a transaction where two or more entities form a new entity. The venture transaction relates to a number of events, including a merger, acquisition, joint venture, divestiture, and others. The present invention generally relates to these and other venture transaction and the need of predicting the information technology (IT) capabilities of the new entity. Preferably, such prediction minimizes problems arising with the IT capabilities of the new entity being incompatible or failing to be safe and legal.

In a merger, for example, IT capabilities from company A may merge with IT capabilities from company B. The new entity, may included IT capabilities from one or both of the IT capabilities of entities A and B. The IT capabilities of company A and B should be taken into account in analyzing a proposed venture transaction (merger). This can help insure against the loss of IT capabilities after the proposed venture transaction takes effect. The process of the present invention is adaptable to any combination of IT capabilities that may result from the merger or other venture transaction. In other words, the present invention is adoptable to the new entity including IT services from both company A and B, from only A, and from only B.

The IT capabilities of a business generally encompass the study, application, and processing of data. The studying, processing, and application of such data can comprise automatic acquisition, storage, manipulation, transformation, management, movement, control, display, switching, interchange, transmission or reception of the data. In addition, the data can be developed and used within various hardwares, softwares, firmwares, and other processes. To minimize the loss of these IT capabilities, a number of IT operations need to be evaluated for losses of business services or assets during the venture transaction. Such areas include the loss of IT capabilities due to violations of third party software license agreements, loss of intellectual property, inappropriate sharing of data and IT incompatibilities.

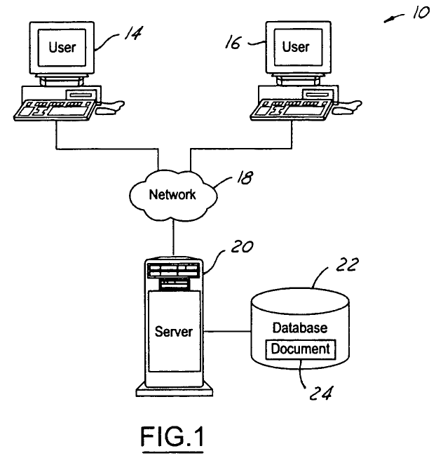

FIG. 1 illustrates a computer-implemented system 10 in accordance with the present invention. The system comprises one or more user computers 14 and 16, a network 18, a server 20, and a database 22. A user can access the server and the database through the user computer 14 and the network 18 in a conventional manner, as one of ordinary skill in the art will appreciate.

The user computer 14 can include a graphical user interface or other electronic medium to access data stored in database 22. In addition, the user computer can upload data to the database 22. Electronically accessible documents 24 provide instructions to facilitate analyzing the venture transaction. The documents 24 can also be accessed by the team. In this manner, data can be used in analyzing the proposed venture transaction. Preferably, a venture team comprising a number of users can upload and review data to facilitate a team work environment.

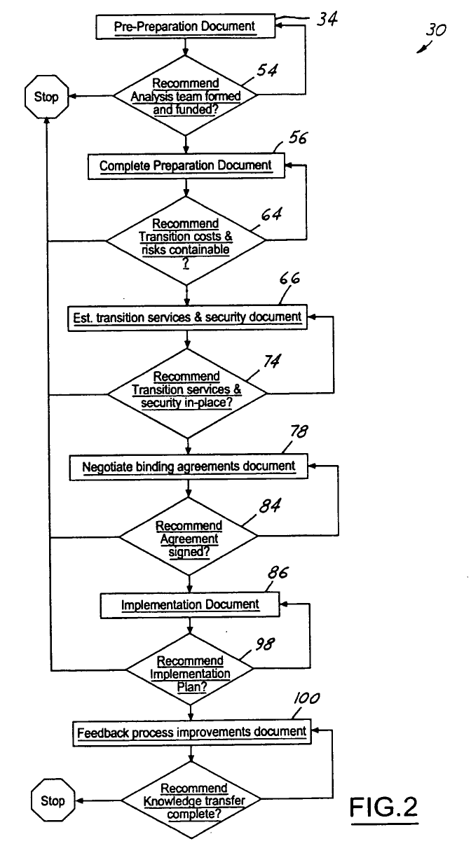

FIG. 2 illustrates a flowchart 30 in accordance with the present invention. The flowchart 30 illustrates a method to analyze a proposed venture transaction. The method facilitates predicting IT capabilities of a new entity formed according to a proposed venture transaction. The system provides a computerized means to execute the method. In particular, the system provides access to the database 22 where a number of electronically accessible documents 24 are maintained. The documents 24 are provided in accordance with the method to facilitate analysis of the venture transaction.

The flowchart 30 provides a general template for use in conducting the analysis of the proposed venture transaction. FIG. 2 can be reproduced on the user computer 14 through the graphical user interface. The underlined portions provide hyperlinks to different analysis and recommendation portions of the method. Documents to facilitate the analysis are accessible by clicking on one of the hyperlinks. In addition, the user can click on the hyperlink to upload data to the database. In this manner, data can be collected for the IT capabilities of each entity and uploaded to the database. The uploaded data is then accessible to other analysis team members.

A step 34 relates to pre-preparation analysis. The pre-preparation analysis begins with the collection of data relating to the IT capabilities of the entities which are to form the new entity. A pre-preparation document 36 is available to facilitate in the data collection and analysis related to the pre-preparation analysis.

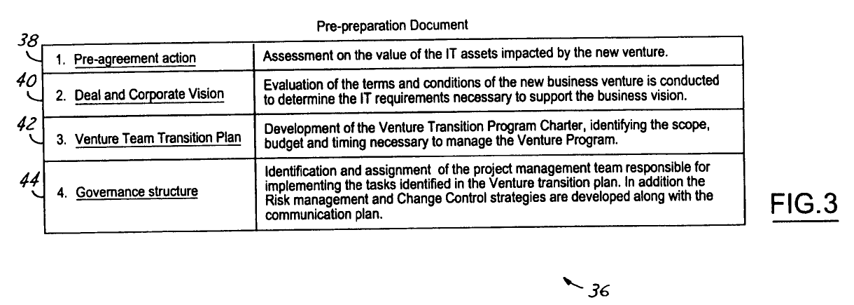

FIG. 3 illustrates the pre-preparation document 36. The pre-preparation document is an electronically accessible document. Analysis instructions for a pre-agreement action analysis 38, a deal and corporate vision analysis 40, a venture team transition plan analysis 42, and a governance structure analysis 44 are included. Further analysis instructions for these analysis instructions are provided with the indicated hyperlinks (underlined portions).

The pre-agreement action 38 instructions generally relate to analyzing and assessing the value of the IT capabilities impacted by the proposed venture transaction. The following table includes further instructions which may be accessed through the hyperlink to facilitate analyzing the pre-agreement action.

TABLE 1
Pre-Agreement Action

| Deliverable | | Description | Responsibility |
|---|---|---|---|
| 1A | Signed Letter of | last | OGC, |
| | Intent | deliverable | BP, NBD |
| 1B | Preliminary Catalogue | in step | VT |
| | of IT Assets | | |
| 1C | List of IT guidelines | | VT |
| | & principles to BP | | |
| 1D | High level forecast | based on | VT |
| | of total IT cost | past | |
| | | experience; | |
| | | it is a ‘bread | |
| | | box’ or a | |
| | | ‘bus’? | |
| Financial | Not Applicable | | |
| Metrics (Budget | | | |
| Quality Metrics | If no Letter of | | |
| | Intent, STOP process | | |
| Timing: Low | Not Applicable | | |
| Complexity | | | |
| Timing: High | Not Applicable | | |
| Complexity | | | |
| Communication | Not Applicable | | |
| Plans | | | |

Table 1 includes a deliverables portion a deliverable description if necessary, an assignment of responsibility, a financial metric, a quality metric, a timing metric for a low complexity venture transaction, a timing metric for a high complexity venture transaction, and a communication plan.

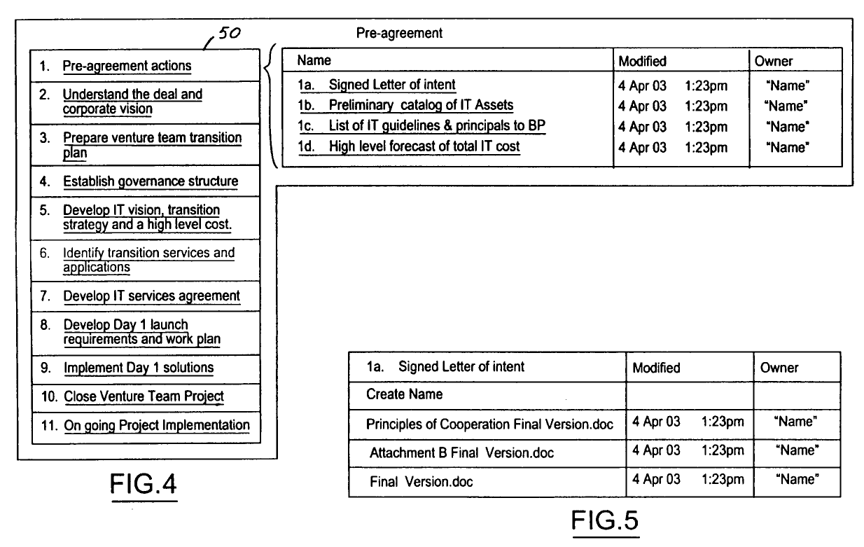

The deliverables portion includes a number of analysis headings. The analysis headings are hyperlinks to additional documentation to facilitate the analysis. For example, a “signed letter of intent” heading can be clicked on to transport the user to a file folder arrangement maintained on the database. An exemplary file folder arrangement 48 is generally shown in FIGS. 4 and 5.

FIG. 4 includes a number of documents to facilitate the analysis of each deliverable. Column 50 provides a navigation means. The navigation means provides hyperlinks to additional instructions and documents. As shown, the pre-agreement actions link was accessed.

FIG. 5 includes further documents to facilitate the analysis under the “signed letter of intent” heading. The documents can include any number file types and characteristics. The files include instructions to facilitate the analysis. The user can download these files from the database or upload files for later use. Any member of the team preferably has access to the files. As such, the files can be examples of different letters of intent, a checklist of questions to ask regarding a letter of intent, a checklist of areas to cover in the letter or intent, and the like. Preferably, each deliverable heading includes a separate file folder arrangement.

Returning to table 1, the deliverable description provides a high level indication of the analysis to be conducted for each deliverable heading. The assignment of responsibility portion indicates a party responsible for different portions of the analysis. The responsible parts depend on whether the analysis is from the point of view of entity A or B. From the point of view of entity A, ADS is the group of people that are responsible for the development and maintenance of business support application software for company A. BP is the person from company A that will be responsible for the new entity once it has been formed. ITI is the group of people that are responsible for the computer infrastructure (hardware/networks) for company A. This may or may not be the same group as ADS. GTI is the person or group of people that are responsible for protecting the intellectual property of company A. MP is a group of people that are subject matter experts on the application software that is affected by the formation of the new entity. The subject matter experts from company A are matched with the subject matter experts from company B. OGC is the legal staffs of company A that are executing the legal agreements for the formation of the new entity. TMT is the group of people from both company A and company B that are empowered to make decisions regarding the formation of the new entity. VBP is the person from company A that is leading the venture transaction. This may or may not be the same as the BP. VIM is the person that will be responsible for the information technology of the new entity after its formation. This can be a person from company A, company B or someone from outside both companies that is brought in to perform this function. VI is the person from company A that is executing the process described in this patent. These designations are common thought different portions of the analysis, as one will appreciate in light of the disclosure below.

The metrics provide guidance to the level of analysis and timing required. Each metric can optionally be a hyperlink to additional documentation in a file folder. The additional documentation can used to facilitate understanding the metric. The communication plan indicates when analysis teams should meet to discuss the analysis and in some cases to make a recommendation.

Returning to FIG. 3, the deal and corporate vision 40 instructions generally relate to analyzing the terms and conditions of the proposed venture transaction to determine the IT requirements necessary to support the IT capabilities of the new entity as determined in a corporate vision. The following table includes further instructions which may be accessed through the hyperlink to facilitate analyzing the deal and corporate vision.

TABLE 2
Deal & Corporation Vision

| Deliverable | | Description | Responsibility |
|---|---|---|---|
| 2A | Completed business | use LOI as input; | VT, BP, NBD, ITI |
| | questionnaire | business case VT, BP, | |
| | containing Business | NBD, w/vision; used to | |
| | Goal, Separation | talk w/MP & IT ITI | |
| | Plan, Ownership | Sponsor and to let IT | |
| | Percent, Business | audience understand; | |
| | Principles | business timetable; for | |
| | | tax & legal | |
| | | implications; IT | |
| | | security, licenses, | |
| | | etc. | |
| 2D | Financial Principles | IT perspectives/ | VT, BP, VIM, ITI |
| | | inference; constitutes | |
| | | what IT ownership; | |
| | | genesis of final IT | |
| | | Services Agreement; | |
| | | sets expectations on | |
| | | how to operate | |
| 2E | Non-Disclosure | Confidentiality | VT, BP (two-way), |
| | Agreement | agreement; pre- | OGC, VIM, NBD (one |
| | | contract; one-way to | way) |
| | | two-way agreement | |
| 2F | Documented IT | List of ways IT wants | VT, BP, ITI, VIM |
| | Transition Principles | to do business (not | |
| | | financial) | |
| 2G | Personnel Principles | How employees are going | VT, BP, VIM |
| | | to be handled; appendix | |
| | | to 2A | |
| 2I | Assessment of Scope | Beginning of list for | VT, ITI |
| | for IT | IT Services Agreement; | |
| | | ITAs impacted; for IT | |
| | | Director to ask for MP; | |
| | | investigate & gather | |
| | | background on buyer; | |
| | | elevator speech; CROP | |
| 2K | ITI representative | Need for scope of IT | VT, ITI |
| | | document | |
| Financial | Not applicable | | |
| Metrics (Budget) | | | |
| Quality Metrics | If no Business case, | | |
| | STOP process | | |
| Timing: Low | 2-4 weeks | | |
| Complexity | | | |
| Timing: High | 2-4 weeks | | |
| Complexity | | | |
| Communication | RYB Report to IT | | |
| plans | Management & BP | | |

The venture transaction plan 42 instructions generally relate to developing a venture transaction program charter and identifying scope, budgeting, and timing necessary to mange the proposed venture transaction. The following table includes further instructions which may be accessed through the hyperlink to facilitate analyzing the venture team transition plan.

TABLE 3
Venture Team Transition Plan

| Deliverable | | Description | Responsibility |
|---|---|---|---|
| 3A | Venture Team Transition | Lay out rest of VT | VT, ITI |
| | process | process; decide how | |
| | | to apply VT process | |
| | | (what deliverables); | |
| | | first draft of | |
| | | project plan; basis | |
| | | for funding | |
| 3B | Venture Team Transition | VT plan for doing the | VT, BP (buy-in), ITI |
| | Schedule | deal; timing for | |
| | | doing the deal; | |
| | | psuedo-charter w/3A & | |
| | | 3C | |
| 3C | Approved initial Budget | VT travel & IT | VT (Low + .3FTE, Hi + |
| | for Delivering the | consultant time to | .5FTE, annually) |
| | Transition Plan | develop deliverables; | |
| | | not MP cost or | |
| | | executing | |
| | | deliverables; payment | |
| | | depends on the | |
| | | venture | |
| 3D | Draft IT Services | Only attachments; | VT, ITI |
| | Agreement | catalogue of IT | |
| | | services; legal | |
| | | language; use | |
| | | templates; input for | |
| | | meeting w/potential | |
| | | IT Sponsor | |
| Financial | If no VT Funding (3C), | | |
| Metrics | STOP process | | |
| (Budget) | | | |
| Quality Metrics | BP buy-in to 3A, 3B, 3C | | |
| Timing: Low | 1 week | | |
| Complexity | | | |
| Timing: High | 1-2 weeks | | |
| Complexity | | | |

The governance structure 44 instructions generally relate to identifying and assigning members of the venture team responsibilities for implementing the tasks identified in the venture transaction plan. In addition, risk management and change control strategies are developed. The following table includes further instructions which may be accessed through the hyperlink to facilitate analyzing the governance structure.

TABLE 4
Transition Process Establish Governance Structure

| Deliverable | | Description | Responsibility |
|---|---|---|---|
| 4A | Matched Pairs & TMT | Roles & | VT, IT Mgt, VIM, ITI |
| | assigned w/contact | Responsibilities; | |
| | info (e-mail | used to level-set | |
| | address, phone | for Ford IT Sponsor; | |
| | number, pager | how work together; | |
| | number, etc.) | includes IT Finance | |
| 4B | Assigned ADS Project | New practice | VT, ADS Mgt |
| | MGT & Program Mgt | | |
| 4C | Communication | Who meets with whom, | TMT, key people |
| | Strategy (all | and when they meet | |
| | directions; Sr Mgt, | | |
| | MP, BP . . . ) | | |
| 4D | Risk Management & | Decide how to manage | VT, IT Sponsor, VIM |
| | Change Control | change; it is the | |
| | Strategy | process to deliver | |
| | | 5D; use change | |
| | | management forms; | |
| | | generic and venture- | |
| | | specific risks | |
| 4E | Ford Business | Who is responsible | 0 |
| | Project Leader | (on PR); not on TMT | |
| | Identified | or Executive Sponsor | |
| 4F | Venture Business | Counterpart to 4E; | VBP |
| | Project Leader | part of NewCo | |
| | Identified | | |
| 4G | Ford IT Sponsor | Selection driven by | VT, IT Mgt |
| | accepts & agrees to | BP goals; includes R & | |
| | take responsibility | R; presumption for | |
| | | assuming long run | |
| | | responsibility; | |
| | | still owns relation | |
| | | w/customer; | |
| | | approval for | |
| | | additional | |
| | | governance to #3 | |
| | | (charter) | |
| Financial Metrics | Not Applicable | | |
| (Budget | | | |
| Quality Metrics | If not ALL matched | | |
| | pairs, STOP process | | |
| Timing: Low | 2-4 weeks | | |
| Complexity | | | |
| Timing: High | 2-4 weeks | | |
| Complexity | | | |

| | | |
|---|---|---|
| Communication Plans | Gate Review | WHO: IT Sponsor, Exec Sponsor, Venture |
| | | Business Sponsor, VIM, Venture IT Project |
| | | Manager |
| | | WHAT: Understand the deal, Approval of |
| | | Transition Plan (resources & funding), |
| | | Governance structure/R&R, and Principles |

The communication plan shown in table 4 notes a gate review. The gate review corresponds with the diamond shaped outlines shown in FIG. 2. A recommendation to proceed with analysis of the proposed venture transaction is made at each gate review.

The recommendation can comprise recommending to proceed with the analysis, recommending to re-do or collect additional data according to the one or more of the preceding documents, or stopping any further analysis of the proposed venture transaction. The recommendation is made by venture transaction team members or by upper management individuals. The recommendation is preferably based upon the IT capabilities data collected from each entity and analyzed according to the documentation corresponding with the recommendation. Each recommendation portion includes a hyperlink to a file folder, like the one shown in FIGS. 4 and 5.

Additional documentation and instructions can be included in the file folder to facilitate analyzing and making the recommendation. In addition, a who and what description can be provided to indicate the individual who should be involved with the recommendation and to indicate what the recommendation should cover.

A step 54 relates to the recommendation made after finishing the pre-preparation analysis step 34. The step 50 recommends whether an analysis team is formed and funded. A positive recommendation should occur before further analysis of the proposed venture transaction.

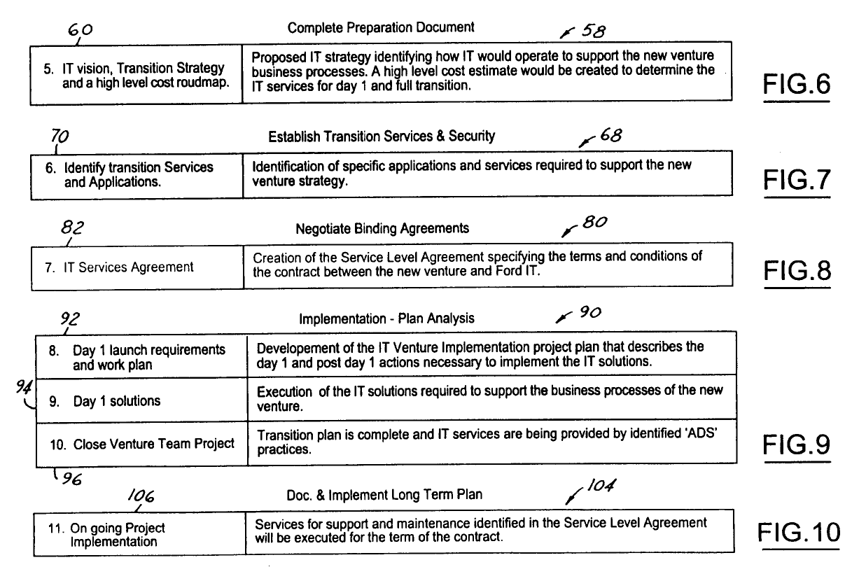

A step 56 relates to a complete preparation analysis if a positive recommendation is received in step 54. A complete preparation document 58 is available to facilitate in the data collection and analysis, as shown in FIG. 6. The complete preparation document 58 includes instructions to facilitate analyzing the proposed venture transaction. Analysis instructions 60 for analyzing an IT vision, a transition strategy, and a high level cost roadmap are provided. Further analysis instructions for these analysis instructions are accessible through the hyperlink. In general, the instructions relate to analyzing how IT would operate to support the proposed venture transaction and analyzing what a high level cost estimate would indicate for the IT services due on day-one for a full transaction. The following table includes further instructions which may be accessed through the hyperlink to facilitate analyzing the information technology vision, the transition strategy, and the high level cost roadmap.

TABLE 5
Complete Preparation

| Deliverable | | Description | Responsibility |
|---|---|---|---|
| 5A | IT Vision & | General IT strategy; | VT, MP, ADS, ITI, |
| | Transition Strategy | IT organizational | TMT, IT Sponsor, |
| | for Day 1, post Day | planning; to | Stakeholders |
| | 1, and fully | communicate back to | |
| | transitioned (WHAT) | business; need NewCo | |
| | | business processes | |
| | | w/inference on | |
| | | timing; future | |
| | | support vision (for | |
| | | ADS and/or PTG) | |
| 5B | Open IT Issues List | | VT, MP, ADS, VIM |
| 5C | High Level Funding | Budget (line item) | VT, MP, ADS, BP, IT |
| | Plan for Day 1 - | allocation; | Sponsor, VIM, TMT, |
| | approved (HOW MUCH) | agreement on how to | ITI |
| | | pay for IT services | |
| | | on Day 1; how much, | |
| | | who pay, when pay, | |
| | | and for what | |
| 5D | Risk Management List | Identify generic & | VT, MP |
| | | venture-specific | |
| | | risks & how to | |
| | | mitigate, potential | |
| | | issues; internal | |
| | | document; risks from | |
| | | IT viewpoint; output | |
| | | of 4D list | |
| 5E | Due Diligence Report | Research and leg | VT, MP, ITI, VIM |
| | | work; questionnaire | |
| | | results; Lawton's | |
| | | ‘Dig-A-Hole & Look’ | |
| | | example | |
| Financial Metrics | If funding problems | | |
| (Budget) | or lack of approval, | | |
| | elevate to Business | | |
| | Sponsor | | |
| Quality Metrics | Adherence to timing, | | |
| | etc. CHECKPOINT with | | |
| | IT Sponsor | | |
| Timing: Low | 2-4 weeks | | |
| Complexity | | | |
| Timing: High | 6-12 weeks | | |
| Complexity | | | |

| | | |
|---|---|---|
| Communication Plans | Gate Review | WHO: It Sponsor, Executive Sponsor, Venture |
| | | Business Partner, VIM/Sponsor |
| | | WHAT: Approval of IT vision, Strategy/ |
| | | Timing/Phasing, Costs, Issues/Risks, |
| | | Resourcing, NB High Level, Due Diligence |
| | | Report |

A step 64 relates to the recommendation made after finishing the complete preparation analysis step 54. The step 64 recommends whether transition costs and risks are attainable. The recommendation is preferably based upon the data collected from each entity and analyzed according to the documentation corresponding with the complete analysis instructions.

A step 66 relates to an establish services and security analysis if a positive recommendation is made in step 64. A establish transition services and security document 68 is available to facilitate in the data collection and analysis, as shown in FIG. 5. The document includes instructions to facilitate analyzing the proposed venture transaction. Analysis instructions for analyzing transition services and applications 70 is provided. Further analysis instructions are accessible through the hyperlink. In general, the instructions relate to analyzing specific applications and services required to support the proposed venture transaction. The following table includes further instructions which may be accessed through the hyperlink to facilitate analyzing the transition services and applications.

TABLE 6
Establish Transition Services & Security

| Deliverable | | Description | Responsibility |
|---|---|---|---|
| 6A | IT Services | List of applications & | VT, MP |
| | Inventory | infrastructure | |
| | | services; all we | |
| | | want to charge for - | |
| | | impacted by; IT | |
| | | Asset Inventory; | |
| | | stub used for input | |
| | | to 6B | |
| 6B | Disposition Plan | Includes MP time | VT, MP, VIM, ADS |
| | (Costed, Multi-year) | (recoupable staff | |
| | | time) by | |
| | | application; | |
| | | remainder of info | |
| | | that was started in | |
| | | 6A | |
| 6C | Billing Summary | Cost of transition | VT, MP, IT Finance |
| | (Post Day 1) | services (also from | |
| | | 6A); IT Finance | |
| | | (Tigue) can Finance | |
| | | not charge more; | |
| | | infrastructure | |
| | | included; usage | |
| | | based; MP could bill | |
| | | for time | |
| 6F | Security Control | Includes Audit | ITI, VT |
| | Plan | Compliance Strategy, | |
| | | Access Security | |
| | | Plan, and Record | |
| | | Retention Plan; GIS/ | |
| | | ACR/CSM | |
| | | requirements | |
| 6H | High-level Timing | Major events | VT, MP, ADS Program |
| | for Major Transition | timetable; project | Mgt |
| | Events (WHEN) | plan for the deal; | |
| | | take care of | |
| | | unacceptable risks; | |
| | | includes billing | |
| | | codes, addresses | |
| | | (etc.) | |
| 6J | Billing Process, | Infrastructure and | IT Finance, VT, ITI |
| | Codes, and | applications | |
| | Addresses, etc. | | |
| | (identified & | | |
| | agreed) | | |
| Financial Metrics | If funding issues, | | |
| (Budget) | STOP process | | |
| Quality Metricts | If Gate Review not | | |
| | conducted, STOP | | |
| | process | | |
| Timing: Low | 2-4 weeks | | |
| Complexity | | | |
| Timing: High | 4-6 weeks | | |
| Complexity | | | |

| | | |
|---|---|---|
| Communication Plans | Gate Review | WHO: IT Sponsor, Executive Sponsor, VIM, |
| | | Venture Business |
| | | WHAT: Costs/billing forecast, services, |
| | | timing/phasing, IT Service Summary, agree |
| | | to basic terms of service agreement |

A step 74 relates to the recommendation made after finishing the establish services and security analysis. The step 74 recommends whether adequate transaction services and security are in-place. The recommendation is preferably based upon data collected from each entity and analyzes according to the documentation corresponding with the establish transition services and security document.

A step 78 relates to a negotiate binding agreement analysis if a positive recommendation is made in step 74. A negotiate binding agreement document 80 is available to facilitate in the data collection and analysis as shown in FIG. 8. The document includes instructions to facilitate analyzing the proposed venture transaction. Analysis instructions for analyzing an IT services agreement 82 are provided. Further analysis instructions are accessible through the hyperlink. In general, the instructions relate to analyzing and creating a serve level agreement specifying the terms and conditions of the contract between the entities forming the new entity. The contract is relied upon by the entities to conduct the proposed venture transaction. The following table includes further instructions which may be accessed through the hyperlink to facilitate analyzing the developing the IT services agreement.

TABLE 7
IT Negotiate Binding Agreement

| Deliverable | | Description | Responsibility |
|---|---|---|---|
| 7A | IT Services | Who is long-run | VT, OGC, IT Sponsor, |
| | Agreement (IT & OGC) | PTG?; Is PTG | Smed, BP, VIM, CIO |
| | | needed?; need | |
| | | governance model; | |
| | | must be agreed by | |
| | | all parties | |
| 7B | IP Use/Transfer | IT-related IP; | VT, FGTI, Smed, BP, |
| | Agreement (FGTI) for | identify IP to | VIM, CIO |
| | software | transfer (e.g. plant | |
| | | floor systems must | |
| | | have license from | |
| | | FGTI; 6 Sigma | |
| | | software) | |
| Financial Metrics | Not Applicable | | |
| (Budget) | | | |
| Quality Metrics | If IT Services | | |
| | Agreement not | | |
| | signed, STOP process | | |
| Timing: Low | 2-3 weeks | | |
| Complexity | | | |
| Timing: High | 6-8 weeks | | |
| Complexity | | | |

| | | |
|---|---|---|
| Communication Plans | Gate Review | Meeting with CIO |

A step 84 relates to the recommendation made after finishing the negotiate binding agreement analysis. The step 84 recommends whether to execute the negotiated binding agreement. The recommendation is preferably based upon data collected from each entity and analyzes according to the documentation corresponding with the negotiate binding agreement document.

A step 86 relates to an implementation plan analysis if a positive recommendation is made in step 84. A implementation plan document 90 is available to facilitate in the data collection and analysis, as shown in FIG. 6. The document includes instructions to facilitate analyzing the proposed venture transaction. Analysis instructions for analyzing day-one launch requirements and work plan 92, day-one solutions 94, and closure of a venture team project 96 are provided. Further analysis instructions are accessible through the hyperlinks. In general, the instructions relate to analyzing development of an IT venture implementation project plan. Preferably, the project plan describes day-one in post day-one actions necessary to implement IT solutions. The instructions can also analyze execution of the IT solutions required to support the business processes of the proposed venture transaction, and to analyze a complete transition plan of IT services provided by identified “ADS” practices. The following tables include further instructions which may be accessible through the hyperlinks to facilitate analyzing the implementation plan.

TABLE 8
Day-1 Launch Requirements And Work Plan

| Deliverable | | Description | Responsibility |
|---|---|---|---|
| 8A | Day-1 | Very detailed | VT, MP, |
| | Launch Support | ‘What has to | ADS, VIM, |
| | Plan | Happen for | ITI |
| | | Day 1’; hour- | |
| | | by-hour plan; | |
| | | business | |
| | | requirements | |
| Financial Metrics | Not Applicable | | |
| (Budget) | | | |
| Quality Metrics | If documents for | | |
| | turnover not | | |
| | complete, STOP | | |
| | process | | |
| Timing: Low | 1 week | | |
| Complexity | | | |
| Timing: High | 2 weeks | | |
| Complexity | | | |
| Communication | Not | | |
| plans | Applicable | | |

TABLE 9
Day 1 Solutions

| Deliverable | | Description | Responsibility |
|---|---|---|---|
| 9A | Successful Launch | All major issues | VT, ADS, IT Sponsor |
| | | solved; start of | |
| | | operations | |
| Financial Metrics | If no billing | | |
| (Budget) | commitment, STOP | | |
| | process | | |
| Quality Metrics | Is the venture | | |
| | “Legal” (security, | | |
| | OGC Compliance | | |
| Timing: Low | Not Applicable | | |
| Complexity | | | |
| Timing: High | Not Applicable | | |
| Complexity | | | |
| Communication Plans | Post Day #1 Status | | |
| | Report | | |
| 9B | Successful Launch | All major issues | VT, ADS, IT Sponsor |
| | | solved | |
| Financial Metrics | Not Applicable | | |
| (Budget) | | | |
| Quality Metrics | Not Applicable | | |
| Timing: Low | +100 days | | |
| Complexity | | | |
| Communication Plans | Not Applicable | | |

TABLE 10
Closure of Venture Team Project

| Deliverable | | Description | Responsibility |
|---|---|---|---|
| 10A | Lessons Learned | Collect throughout | *VT, BP, ADS |
| | | the process; collect | |
| | | at end of each | |
| | | venture; discuss at | |
| | | recurring roundtable | |
| 10B | Project Performance | RYG Report; | *VT, IT Finance |
| | Chart (measure of | dashboard | |
| | scheduled vs. | | |
| | actual) | | |
| 10C | Quality | Meeting w/all | *VT, BP, VIM, ADS, |
| | Understanding | appropriate players; | IT Mgt, ITI |
| | (measure of | how did we do?; take | |
| | satisfiers vs. | action to fix | |
| | dissatisfiers | | |
| 10E | Program Charter | Post Day 1 turnover | VT, *ADS, MP, VIM |
| | | vision & plan to | |
| | | ADS; occurs about | |
| | | Day 1/post Day 1; | |
| | | verify that ADS gets | |
| | | it & knows what to | |
| | | do; the baton is | |
| | | passed to ADS | |
| 10F | Report of on-going | Funding, | *VT, ADS |
| | project status/ | requirements, | |
| | health | program charter | |
| | | reflects all | |
| | | projects that are | |
| | | involved; formal | |
| | | turnover of | |
| | | responsibility to | |
| | | ADS | |
| Financial Metrics | Not Applicable | | |
| (Budget) | | | |
| Quality Metrics | If all VT post- | | |
| | project document | | |
| | complete, OK to | | |
| | CLOSE | | |
| Timing: Low | Not Applicable | | |
| Complexity | | | |
| Timing: High | Not Applicable | | |
| Complexity | | | |

| | | |
|---|---|---|
| Communication Plans | Gate Review | WHO: ADS, VTT, VIM, Venture Business, IT |
| | | Sponsor, Executive Sponsor |
| | | WHAT: Sign-off on Day 1/Post Day 1, |
| | | Program Charter, Objectives/Deliverables, |
| | | Timing, Costs, Roles & Responsibilities |

A step 98 relates to the recommendation made after finishing the implementation analysis. The step 98 recommends whether to proceed with the proposed venture transaction according to the implementation plan. The implementation plan would then be used in transferring the information technology capabilities of each entity which are to comprise the information technology capabilities of the entity formed according to the proposed venture transaction.

A step 100 relates to a feedback process improvements analysis if a positive recommendation is made in step 98. A feedback process improvement document is available to facilitate the data collection and analysis, as shown in FIG. 10. The document 106 includes instructions to facilitate analyzing the proposed venture transaction. Analysis instructions for analyzing on-going project implementation actions 106 is provided. Further analysis instructions are accessible through the hyperlink. In general, the instructions relate to analyzing services for support and maintenance as identified in the service level agreement which can be executed for the term of the contract. The following table includes further instructions which may be accessed through the hyperlink to facilitate analyzing the feedback process improvements.

TABLE 11
Chapter 11 - Implement Transition Strategy

Services for support and maintenance identified in the Service Level
Agreement will be executed for the term of the contract.

While the best mode for carrying out the invention has been described in detail, those familiar with the art to which this invention relates will recognize various alternative designs and embodiments for practicing the invention as defined by the following claims.

1. In a computerized system, a method to analyze a proposed venture transaction between at least two entities to predict information technology capabilities of an entity formed according to the proposed venture transaction, the method comprising:
collecting data regarding the information technology capabilities of the entities;
accessing a computerized system to review one or more of a number of electronically accessible documents maintained on the computerized system;
analyzing the collected data to determine which of the information technology capabilities of each entity are to comprise the information technology capabilities of the entity formed according to the proposed venture transaction, wherein one of the electronically accessible documents provides instructions to facilitate analyzing the collected data; and
recommending whether to proceed with the proposed venture transaction based upon the information technology capabilities of the entity formed according the proposed venture transaction.

2. The method of claim 1 further comprising recommending an implementation plan for use in transferring the information technology capabilities of each entity which are to comprise the information technology capabilities of the entity formed according to the proposed venture transaction, wherein the implementation plan is recommended in accordance with analysis instructions provided in an implementation plan document electronically maintained in the computerized system and only after recommending to proceed with the proposed venture transaction.

3. The method of claim 2 further comprising recommending execution of an venture transaction agreement prior to recommending the implementation plan, wherein the venture transaction agreement is relied upon by the entities to conduct the proposed venture transaction and determined in accordance with analysis instructions provided in a negotiate binding agreements document electronically maintained in the computerized system.

4. The method of claim 3 further comprising recommending adequate transition capabilities and security are in-place prior to recommending execution of the venture transaction agreement, wherein the transition capabilities and security are recommended to be in-place in accordance with analysis instructions provided in an establish transition capabilities and security document electronically maintained in the computerized system.

5. The method of claim 4 further comprising recommending transition costs and risks are containable prior to recommending adequate transition capabilities and security are in-place, wherein the transition costs and risks are recommended to be containable in accordance with analysis instructions provided in a complete preparation document electronically maintained in the computerized system.

6. The method of claim 5 further comprising recommending an analysis team as being formed and funded prior to recommending transition cost and risks are containable, wherein the analysis team is recommended to be formed and funded in accordance with analysis instructions provided in a pre-preparation document electronically maintained in the computerized system.

7. The method of claim 6 further comprising recommending to transfer knowledge to the computerized system, wherein the transferred knowledge comprises additional documentation having analysis instructions for use in adding to the analysis instructions maintained by the computerized system.

8. The method of claim 7 wherein the analysis instructions provided by the pre-preparation document relate to instructions to facilitate analyzing pre-agreement actions, a deal and corporate vision, a venture team transition plan, and a governance structure.

9. The method of claim 8 wherein the analysis instructions provided by the complete preparation document relate to instructions to facilitate analyzing an information technology vision, a transition strategy, and a high level cost roadmap.

10. The method of claim 9 wherein the analysis instructions provided by the negotiate binding agreements document relate to instructions to facilitate analyzing an information technology capabilities agreement.

11. The method of claim 10 wherein the analysis instructions provided the implementation document relate to instructions to facilitate analyzing day-one launch requirements and work plan, day-one solutions, and closure of a venture team project.

12. A computer system to analyze a proposed venture transaction between at least two entities to predict information technology capabilities of an entity formed according to the proposed venture transaction, the computer system comprising:
a user computer to facilitate collecting data regarding the information technology capabilities of the entities and reviewing one or more of a number of electronically accessible documents maintained on the computerized system;
wherein one of the electronically accessible documents provides instructions to facilitate analyzing the collected data to determine which of the information technology capabilities of each entity are to comprise the information technology capabilities of the entity formed according to the proposed venture transaction; and
wherein one of the electronically accessible documents provides instructions to facilitate recommending whether to proceed with the proposed venture transaction based upon the information technology capabilities of the entity formed according the proposed venture transaction.

13. The computer system of claim 12 wherein one of the electronically accessible documents provides instructions to facilitate recommending an implementation plan for use in transferring the information technology capabilities of each entity which are to comprise the information technology capabilities of the entity formed according to the proposed venture transaction, wherein the implementation plan is recommended in accordance with analysis instructions provided in an implementation plan document electronically maintained in the computerized system and only after recommending to proceed with the proposed venture transaction.

14. The computer system of claim 13 wherein one of the electronically accessible documents provides instructions to facilitate recommending execution of an venture transaction agreement prior to recommending the implementation plan, wherein the venture transaction agreement is relied upon by the entities to conduct the proposed venture transaction and determined in accordance with analysis instructions provided in a negotiate binding agreements document electronically maintained in the computerized system.

15. The computer system of claim 14 wherein one of the electronically accessible documents provides instructions to facilitate recommending adequate transition capabilities and security are in-place prior to recommending execution of the venture transaction agreement, wherein the transition capabilities and security are recommended to be in-place in accordance with analysis instructions provided in an establish transition capabilities and security document electronically maintained in the computerized system.

16. The computer system of claim 15 wherein one of the electronically accessible documents provides instructions to facilitate recommending transition costs and risks are containable prior to recommending adequate transition capabilities and security are in-place, wherein the transition costs and risks are recommended to be containable in accordance with analysis instructions provided in a complete preparation document electronically maintained in the computerized system.

17. The computer system of claim 16 wherein one of the electronically accessible documents provides instructions to facilitate recommending an analysis team as being formed and funded prior to recommending transition cost and risks are containable, wherein the analysis team is recommended to be formed and funded in accordance with analysis instructions provided in a pre-preparation document electronically maintained in the computerized system.

18. The computer system of claim 16 wherein one of the electronically accessible documents provides instructions to facilitate recommending to transfer knowledge to the computerized system, wherein the transferred knowledge comprises additional documentation having analysis instructions for use in adding to the analysis instructions maintained by the computerized system.

19. The computer system of claim 18 wherein the analysis instructions provided by the pre-preparation document relate to instructions to facilitate analyzing pre-agreement actions, a deal and corporate vision, a venture team transition plan, and a governance structure.

20. In a computerized system, a method to analyze a proposed venture transaction between at least two entities to predict information technology capabilities of an entity formed according to the proposed venture transaction, the method comprising:
collecting data regarding the information technology capabilities of the entities;
accessing a computerized system to review one or more of a number of electronically accessible documents maintained on the computerized system;
analyzing the collected data to determine which of the information technology capabilities of each entity are to comprise the information technology capabilities of the entity formed according to the proposed venture transaction, wherein one of the electronically accessible documents provides instructions to facilitate analyzing the collected data;
recommending whether to proceed with the proposed venture transaction based upon the information technology capabilities of the entity formed according the proposed venture transaction;
recommending an implementation plan for use in transferring the information technology capabilities of each entity which are to comprise the information technology capabilities of the entity formed according to the proposed venture transaction, wherein the implementation plan is recommended in accordance with analysis instructions provided in an implementation plan document electronically maintained in the computerized system and only after recommending to proceed with the proposed venture transaction;
recommending execution of an venture transaction agreement prior to recommending the implementation plan, wherein the venture transaction agreement is relied upon by the entities to conduct the proposed venture transaction and determined in accordance with analysis instructions provided in a negotiate binding agreements document electronically maintained in the computerized system;
recommending adequate transition capabilities and security are in-place prior to recommending execution of the venture transaction agreement, wherein the transition capabilities and security are recommended to be in-place in accordance with analysis instructions provided in an establish transition capabilities and security document electronically maintained in the computerized system;
recommending transition costs and risks are containable prior to recommending adequate transition capabilities and security are in-place, wherein the transition costs and risks are recommended to be containable in accordance with analysis instructions provided in a complete preparation document electronically maintained in the computerized system;
recommending an analysis team as being formed and funded prior to recommending transition cost and risks are containable, wherein the analysis team is recommended to be formed and funded in accordance with analysis instructions provided in a pre-preparation document electronically maintained in the computerized system; and
recommending to transfer knowledge to the computerized system, wherein the transferred knowledge comprises additional documentation having analysis instructions for use in adding to the analysis instructions maintained by the computerized system.
